(19) United States
(12) Patent Application Publication
(10) Pub. No.: US 2006/0224543 A1
(43) Pub. Date: Oct. 5, 2006

(54) Guidance system

(76) Inventors: John Richard Clymer, Placentia, CA (US); Lary Don Smith, Fullerton, CA (US)

Correspondence Address: MICHAEL A. SHIPPEY, PH. D., 4848 LAKEVIEW AVENUE, SUITE B, YORBA LINDA, CA, 92886, US

(21) Appl. No.: 11/099,785

(22) Filed: Apr. 5, 2005

(51) Int. Cl. G06N 5/02

(52) U.S. Cl. 706/47

(57) ABSTRACT

A Feature Map and learning rule-based Classifier capability is demonstrated that maximizes performance of classifier decisions. The invention discriminates among a large set of cases to make the correct decision for each case and generalizes well by correctly deciding cases never seen before. The Feature Map capability consists of Kohonen Self Organizing Feature Map (SOFM) followed by a four layer Evolutionary Perceptron. During training, the SOFM learns a set exemplars, one for each case. In operation, the SOFM takes an input state vector and maps it into the closest exemplar. The Evolutionary Perceptron uses algorithms that evolve both the NN weights and sigma (step size) and has two hidden layers required to discriminate nonlinear class boundaries. A population of NNs is evolved from generation to generation by modifying weights and sigma values. The evolutionary programming approach in the classifier capabiliy is used to search through from most general to most specific rules.

### STATEMENT REGARDING FEDERALLY SPONSORED RESEARCH OR DEVELOPMENT

The U.S. Government may have a paid-up license in this invention and the right in limited circumstances to require the patent owner to license others on reasonable terms as provided for by the terms of Reference Contract H0006-03-C-0007 awarded by the Department of Defense.

### BACKGROUND OF INVENTION

1. Field of Invention

The invention involves a rule-based learning classifier system that can discover a set of rules in such a way as to maximize decision making success to achieve system objectives. The learning method uses evolutionary optimization techniques that require only an evaluation of the decision and do not require that the correct decision be known for every case. The range of applications is very broad. A decision can be a classification of cases into N classes, a set of alternative actions that achieve system goals, or a sequence of actions (a plan) that maximizes the total reward achieved by the plan. Using fuzzy facts and rules, a decision can be an analog value used to control a process such as a traffic light. The invention can be trained offline using a training set of cases or online using a simulation model to generate the training cases. The latter allows the invention to be used in developing co-evolutionary systems where the environment is changed by the interaction of learning agents.

2. Description of Related Art

A rule-based learning classifier system can discover a set of rules that maximizes decision making success in order to achieve system objectives. The rule space, and thus learning time and memory required, increases exponentially with the number of feature facts (feature=value) that are possible as rule conditions and actions. If the input to the classifier is a large environmental state vector (case) that contains all possible information that may be relevant to the required decision, then two problems exist: (1) reducing the number of state vector dimensions to an acceptable level for rule learning and (2) dividing the range of values for each state dimension into crisp or fuzzy sets, and thus a set of feature facts, that cover the range and provide a complete set of rule conditions.

The Classifier system must discriminate correctly among a very large set of cases in order to make the proper decision for each case. A decision can be a classification of cases into N classes, a set of alternative actions that achieve system goals, or a sequence of actions (a plan) that maximizes the total reward achieved by the plan. Using fuzzy facts and rules, a decision can be an analog value used to control a process such as a traffic light. The following is extracted from “Simulation-Based Engineering of Complex Systems,” chapter 8 with permission of the author.

Theory of Inductive Learning of Decision Making Rules

The situational universe is defined as the set U of all possible combinations of available condition facts. A situation S is a subset of U, a collection of related elements from this universe. Each element in set S is associated with the same correct decision (one or more required actions). A single element of the universe combined with the correct decision is called a case. Given a randomly selected element u from U, the problem is to decide if u is contained in S. A set of rules must be found to decide if an element u is contained in S or not. For off-line rule induction, training set Q=P+N is a randomly selected subset of positive cases P from S of the situation to be decided plus other negative cases N contained in U and not contained in S. Off-line induction requires that the correct decision be known in order to discover the best rules. On-line induction does not have this information provided, and it must infer the best decision through rule strength modification provided through graded learning. In other words, a set of eligible rules competes to determine what is the best decision for each situation that can occur. Thus, the off-line induction algorithm, discussed here, is an example of supervised learning where the correct answer is provided for each case, and on-line induction is an example of graded learning where the result of using a decision is evaluated and a grade is provided for each case either now or later. Either way, there is a correct decision associated with each case, but it may not be available for learning.

Hypothesis space H is the set of all possible hypotheses (expressed as rules) defined on U and the set of all possible associated decisions. A hypothesis is consistent with an unambiguous situation S if it covers cases in P and does not cover any cases in N. In offline induction we have no trouble determining if a hypothesis is consistent since we know the correct decision; however, in on-line induction consistency is determined gradually over time as the hypothesis is evaluated each time it is used. If a situation is ambiguous, then there are no consistent hypotheses.

Version Space is the subset of all hypotheses contained in H that are consistent with situation S. Maximally specific hypotheses HS are consistent and there is no hypothesis more specific and consistent. The dual set HG contains hypotheses that are consistent and there is no hypothesis more general and consistent. Version space is defined by subsets HS and HG. If a subsequent positive case is added to training set Q, hypotheses in subset HS may become more general. If a subsequent negative case is added to training set Q, hypotheses in subset HG may become more specific. As cases are added to Q, version space is reduced until either empty or until only hypotheses defining S remain (HS=HG). If version space is empty, situation S is not definable by H or is ambiguous. Practical algorithms to reduce version space only work where all cases in situation S are covered by a single conjunctive (AND operator) rule, however. Usually, situations require two or more conjunctive rules to cover all cases contained in subset S of universe U. The choice of rules allows for disjuncts (OR operator) in situation S. Inductive bias is the means by which one consistent hypothesis is chosen over another. Bias results if the shortest or the simplest hypotheses are preferred (Occam's razor). Both the off-line and on-line induction algorithms discussed here use the Occam's razor bias to focus the search to find the simplest rules. Off-line induction also uses the best classifier facts first to focus the search. Another bias is to focus rule search toward each situation one at a time. Off-line induction does this by considering only cases for a given decision, and on-line induction does this by considering only rules eligible in a particular situation context for modification. If only rules having the best classifiers persist then the best overall rules are generated. In online induction, a rule that is 100% correct shuts off the search in the context where the rule applies. This focuses the search in contexts not yet completely covered by rules.

Hypothesis error is the probability of drawing a random element u from U where the hypotheses and correct decision disagree. If version space could be reduced until exhausted, either empty or containing only hypotheses defining S, the hypothesis error would go to zero. Exhausting version space may require infinite examples in set Q and set HG may expand exponentially as Q increases, making it computationally infeasible. However, it is possible to draw enough examples “to probably almost exhaust version space.” An inductive bias is used to minimize hypothesis error such that hypotheses and situation differ only by a small set of cases that rarely occur given the real world probability of occurrence of instances. The idea of using the best classifiers first appears a good bias to probably almost exhaust version space. The Classifier capability in this invention does this.

Situations can overlap where an element u of universe U has several different correct decisions associated with it. Such an element is called ambiguous. The ambiguity that results from such elements can be resolved by evaluating the strength of evidence for each alternative decision and selecting that decision having highest strength. If rules eligible in a decision context that have alternative decisions have about the same strength, the ambiguity associated with selecting a decision is high. If one of the eligible rules has a much higher strength than all the other eligible rules, the ambiguity is low. The average decision ambiguity is an output of the Classifier capability that can be used to compare decisions. For example, to evaluate a visual plane that contains many objects, ambiguity can be used in the evaluation of each object to select the least ambiguous action.

This invention evolves a network of functions using evolutionary programming. A population of networks is maintained. Network evolving operators are used to evolve one generation of networks into the next. It learns a network of functions that map a multi-dimensional environmental state vector into a desired output(s) to control a process. Supervisory learning is used that requires the desired output to be known.

### SUMMARY OF INVENTION

A rule-based learning classifier system that can discover a set of rules that maximizes decision making success in order to achieve system objectives. The rule space, and thus learning time and memory required, increases exponentially with the number of feature (value) facts (feature=value) that are possible as rule conditions and actions. If the input to the classifier is a large environmental state vector (case) that contains all possible information that may be relevant to the required decision, then two problems exist: (1) reducing the number of state vector dimensions to an acceptable level for rule learning and (2) dividing the range of values for each state dimension into crisp or fuzzy sets, and thus a set of feature facts, that cover the range and provide a complete set of rule conditions.

The invention consists of a Feature Map and a learning rule-based Classifier capability. The invention discriminates correctly among a very large set of cases in order to make the proper decision for each case, and it generalizes well by correctly deciding cases it has never seen before. The Feature Map capability consists of Kohonen Self Organizing Feature Map (SOFM) followed by a four layer Evolutionary Perceptron. The SOFM learns a set exemplars, one for each case during training. During operation, the SOFM takes an input state vector and maps it into the closest exemplar. The Evolutionary Perceptron uses evolutionary algorithms that evolve both the NN weights and sigma (step size), and it has two hidden layers which are required to discriminate non-linear class boundaries. A population of NNs is evolved from generation to generation by modifying the weights and sigma values. The learning rule-based Classifier capability uses an evolutionary programming approach to search through rule space from the most general to the most specific rules.

The invention learning method uses evolutionary optimization techniques that require only an evaluation of the decision and does not require that the correct decision be known for every case. The range of applications is very broad. A decision can be a classification of cases into N classes, a set of alternative actions that achieve system goals, or a sequence of actions (a plan) that maximizes the total reward achieved by the plan. Using fuzzy facts and rules, a decision can be an analog value used to control a process such as a traffic light.

The invention can be trained offline using a training set of cases or online using a simulation model to generate the training cases. The later allows the invention to be used in developing co-evolutionary systems where the environment is changed by the interaction of learning agents.

A rule-based learning classifier system can discover a set of rules that maximizes decision making success in order to achieve system objectives. The rule space, and thus learning time and memory required, increases exponentially with the number of feature facts (feature=value) that are possible as rule conditions and actions If the input to the classifier is a large environmental state vector (case) that contains all possible information that may be relevant to the required decision, then two problems exist: (1) reducing the number of state vector dimensions to an acceptable level for rule learning and (2) dividing the range of values for each state dimension into crisp sets, and thus a set of feature facts, that cover the range. The Classifier system must discriminate correctly among a very large set of cases in order to make the proper decision for each case. A decision can be a classification of cases into N classes, a set of alternative actions that achieve system goals, or a sequence of actions (a plan) that maximizes the total reward achieved by the plan. All of these types of decisions are applications of this invention.

The Feature Extraction capability maps a large state vector (case) into a relatively small feature vector where the range of values is restricted to 0 to 10. The classifier block divides the 0 to 10 range for each feature dimension into crisp sets, and thus features facts, that can be used to generate rules that can discriminate the cases as required. However, another problem exists here: the Feature Extraction capability must transform each state vector (case) such that feature values in at least one dimension are different in order to discriminate between input cases. In order to preserve the structure of each case in a way that achieves case separability, the feature map attempts to minimize SAMMON error that preserves the structure of the environmental state space as it is mapped to the feature space. What emerges is that feature facts needed to recognize each decision case is structurally separated (maximum Hamming distance) in order to allow rules based on the feature space to have maximum decision performance.

When decision performance and SAMMON error are combined to define map fitness, the feature map preserves the structure of the input vector space as it is mapped to the feature space in a way that achieves case separability for best decision performance. The invention consists of a Feature Map and a learning rule-based Classifier capability. The Feature Map capability consists of Kohonen Self Organizing Feature Map (SOFM) followed by a four layer Evolutionary Perceptron. The SOFM learns a set exemplars, one for each case during training. During operation the SOFM takes an input state vector and maps it into the closest exemplar. Because of this, the invention has outstanding generalization capability, getting the correct decision for cases not in the training set. The Evolutionary Perceptron uses evolutionary algorithms that evolve both the NN weights and sigma (step size), and it has two hidden layers which are required to discriminate non-linear class boundaries. A population of NN is evolved from generation to generation until decision performance is maximized and SAMMON error is minimized as discussed above. The learning rule-based Classifier system uses an evolutionary programming approach to search through rule space from the most general to the most specific rules. In particular, the number of candidates parameter N is used to allow rule generation to stop for a decision that already has N rules that are 100% accurate. This allows rule generation to focus on other decisions, and it allows reinforcement learning to take place where a sequence of rules must be learned to achieve system goals. In addition, the classifier uses rule ambiguity to control rule search. If several rules have the same rule strength but different actions, the situation is ambiguous. If one rule dominates, then ambiguity is minimized.

The invention learning method uses evolutionary optimization techniques that require only an evaluation of the decision and does not require that the correct decision be known for every case. The range of applications is very broad. A decision can be a classification of cases into N classes, a set of alternative actions that achieve system goals, or a sequence of actions (a plan) that maximizes the total reward achieved by the plan. The invention can be trained offline using a training set of cases or online using a simulation model to generate the training cases. The later allows the invention to be used in developing co-evolutionary systems where the environment is changed by the interaction of learning agents. Further, the Classifier capability can use either crisp or fuzzy sets and crisp or fuzzy rules. Therefore, applications that require analog control signals as output such as traffic light control can be accommodated by the invention as well as applications requiring discrete decisions.

### BRIEF DESCRIPTION OF THE DRAWINGS

FIG. 1 reveals a computer display screen of the Feature Extraction NN parameters Dialog.

FIG. 2 shows a computer display screen of the Feature Extraction feature map Dialog.

FIG. 3 illustrates a hierarchical rule network.

FIG. 4 portrays a rule file showing a sample of rules.

FIG. 5 exhibits a computer display screen of the Classifier event action block display Dialog.

FIG. 6 exhibits a computer display screen of the Classifier event action block learning Dialog.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner

The invention consists of a Feature Map and a learning rule-based Classifier capability. The Feature Map capability consists of Kohonen Self Organizing Feature Map (SOFM) followed by a four layer Evolutionary Perceptron. The Evolutionary Perceptron uses evolutionary algorithms that evolve both the NN weights and sigma (step size), and it has two hidden layers which are required to discriminate non-linear class boundaries. Fitness of each Evolutionary Perceptron population member of ten times the quantity one minus the fraction of decision success plus Sammon's Error has been found to work very well. The learning rule-based Classifier capability uses an evolutionary programming approach that applies a set of rule modification operators to search through rule space from the most general to the most specific rules.

Kohonen Self Organizing Feature Map (SOFM).

The Kohonen SOFM has many variations. It can be used to map features from one vector space to another. For example, two actuator arm angles can be mapped to Cartesian coordinates. Here, the Kohonen SOFM is being used to map input vectors into one of a set of exemplars of the same space. The number of Kohonen neurons determines the total number of exemplars possible.

Pal proposed that a set of exemplars, provided by a Kohonen SOFM, be presented to a multi-layer perceptron (MLP). Sammon's Projection algorithm is used to determine the structure preserving response to each exemplar needed to train the MLP using backpropagation or other supervisory learning method. The paper indicated that this approach had good structure preservation performance with decreased execution time as compared to other approaches. The goal was structure preserving dimensionality reduction (feature extraction), but how the reduced feature space was to be used was not discussed.

The goal of this invention is structure preserving dimensionality reduction (feature extraction) to provide features for a learning rule-based classifier system. The mapping algorithm must be capable of supervisory or graded learning because the correct response in each case may not be known. Therefore, an evolutionary multi-layer perceptron is used instead of backpropagation or other supervisory learning method.

The Kohonen SOFM algorithm used in this invention is as follows:

1. Initial weights are randomly selected;

```
//Initialize Kohonen weights and frequency
for (k=O; k<PopSize; k++)
{
  for (i=O; i<NumberKohonenNeurons; i++)
  {
    for G=O;j<25;j++)
      Kohonen- Weights[k] [i][j] = O.O2*(RandomReaIO−O.5);
    Kohonen_Freq[i] = 1 / NumberKohonenNeurons;
  }
}
```

2. Kohonen neurons compete by comparing distance between an input vector and each weight vector. The closest wins the competition and outputs its weights

```
//Input feature vector into Kohonen NN
for 0=0, j<Cnt; j++)
  Kohonen[O][j] = AttrVal[j];
//Kohonen output competition
Magnitude = 1e300;
for (i=O; i<NumberKohonenNeurons; i++)
{
  Kohonen_Sum[i] = 0;
  for 0=0; j<Cnt; j++)
  {
    if(LeamMap)
      Kohonen_Sum[i] = Kohonen_Sum[i] +
        (Kohonen- Weights [CurrentMember] [i] [j] − Kohonen[O][j]) *
        (Kohonen- Weights [CurrentMember] [i][j] − Kohonen[O][j]);
    else
      Kohonen_Sum[i] = Kohonen_Sum[i] +
      (FeatureMap[i][j] − Kohonen[O][j]) *
      (FeatureMap[i][j] − Kohonen[O][j]);
  }
  Kohonen − Sum[i] = SQRT(Kohonen − Sum[i]);
  if (Kohonen_Sum[i] <= Magnitude)
  {
    Magnitude = Kohonen_Sum[i];
    Neuron = i;
  }
}
```

3. During Kohonen learning there is a second competition which allows neurons that have not won the competition very often to be selected. This assures that each neuron represents an equal number of input cases.

```
//Kohonen neuron is designated winner of competition.
//Kohonen output is Kohonen weights for neuron.
//Kohonen frequency balances number of input vectors associated with
each neuron if ( (LeamMap) && (Time Count < MaxTimeCount) )
{
    for 0=0; i<NumberKohonenNeurons; i++) {
        if (i==Neuron)
              Kohonen[l][i] = I;
        else
              Kohonen[l][i] = 0;
        Kohonen_Freq[i] = Kohonen_Freq[i] + Beta *
              (Kohonen[l][i] − Kohonen]req[i]);
      }
    //Kohonen weight adjustment competition
    Magnitude = 1e300;
    for (i=O; i<NumberKohonenNeurons; i++)
      {
          Kohonen_Sum[i] = Kohonen_Sum[i] − Gamma *
            ((l/NumberKohonenNeurons) − Kohonen]req[i] );
          if(Kohonen_Sum[i] <= Magnitude)
          {
            Magnitude = Kohonen_Sum[i];
            Neuron = i;
          }
      }
    //Adjust Kohonen weights.
    if (TimeCount < MaxTimeCount)
      {
          TimeCount = TimeCount + 1;
          Alpha = Nu * (1 − TimeCount/MaxTimeCount);
    } for 0=0; i<NumberKohonenNeurons; i++) {
        if (i == Neuron)
  {
    for 0=0; j<Cnt; j++)
      {
          Kohonen- Weights[CurrentMember] [i][j] = (I-Alpha) *
            Kohonen - Weights[CurrentMember][i][j] +
            Alpha * Kohonen[O][j];
        if( ReaIABS(Kohonen- Weights[CurrentMember][i][j]) <
        0.00001 )
          Kohonen- Weights [CurrentMember] [i] [j] = 0;
    }
}
```

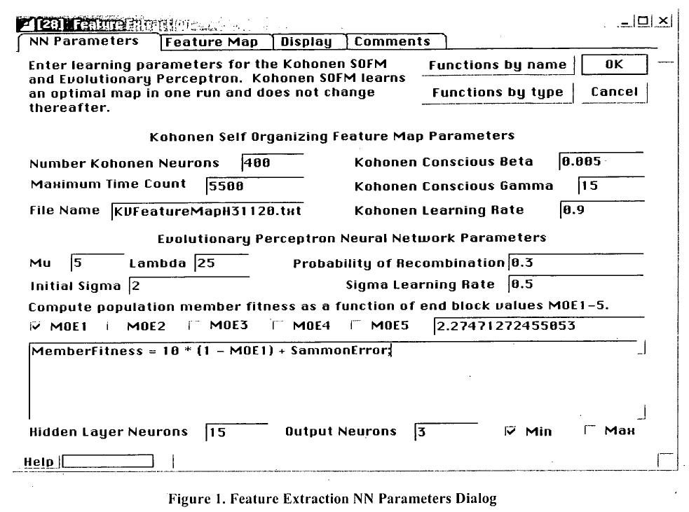

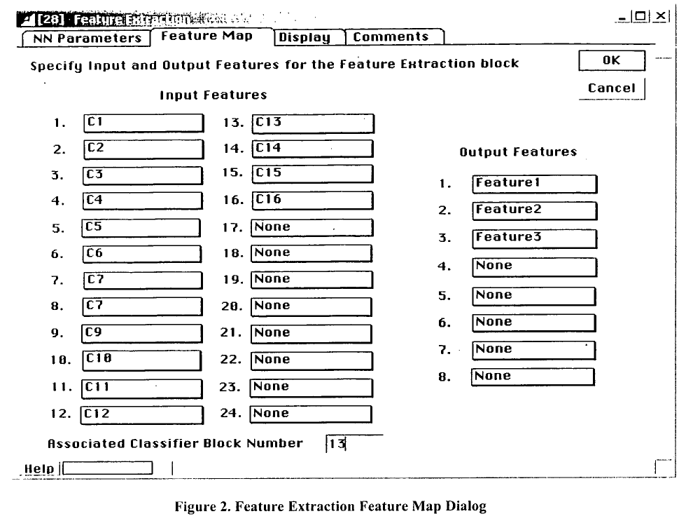

FIGS. 1 and 2 show dialog boxes for the Feature Extraction block. The Feature Extraction block NN Parameters dialog is shown in FIG. 1, These parameters control the learning for the Kohonen SOFM and multi-layer evolutionary perceptron. The parameter values shown were determined through trial and error. The member fitness equation minimizes Sammon error (preserves structure of the signal state vector space) and maximizes discrimination performance achieved by the Classifier block rules. The multi-layer evolutionary perceptron uses two hidden layers which are required to allow a non-linear feature preserving mop to be produced. Research has shown that input Features combine non-linearly to produce output features that are better classifiers.

Dialog Dialog

The Kohonen self-organizing feature map learning parameters used in the algorithm above are as follows:
1. Number of Kohonen Neurons define the maximum number of exemplars;
2. Maximum Time Count is used to reduce the learning rate to zero when the number of cases presented equals the maximum time count;
3. File name of output file to send weights when learning complete;
4. Kohonen Conscious Beta controls the rate at which Kohonen Frequency changes;
5. Kohonen Conscious Gamma is the control gain for the difference between the Kohonen Frequency and equally likely distribution to affect the competition; and
6. Learning Rate is the maximum learning rate modified by the maximum time count cutoff of learning.

Four Layer Evolutionary Perceptron.

The steps of evolutionary algorithm used are as follows [1995 evolutionary computation workshop held in Minneapolis Minn.].
1. Initial weights are randomly selected similar to Kohonen SOFM;
2. Determine fitness of each population member using a simulation run. For example, a total of7500 trial cases are generated for each run of the training program. The first 5500 cases (Maximum Time Count) are required for the Kohonen SOFM to learn the set of exemplars. Rules are generated and tested during this time. From test cases 6500 to 7500, discrimination performance is estimated as discussed above. Fitness is computed as function of decision performance and Sammon Error [21];
3. Use standard bubble sort algorithm to create a ranked list of population members;

4. Apply rank selection to select each population member for mutation or member for recombination. Part of mutation is shown below.

```
procedure Evolve(integer CurrentMember)
{
  integer j, k;
  for(j=O; j<25; j++)
  {
    for(k=O; k<25; k++)
    {
      Ev1_Sigma1[CurrentMember][j][k] =
        EvtSigma1[CurrentMember][j][k] *
          Exp( SigmaLeamingRate * Normal(1));
      if(Ev1_Sigma1[CurrentMember][j][k] < 0.01)
        Ev1_Sigma1[CurrentMember][j][k] = 0.01;
      if(Ev1_Sigma1[CurrentMember][j][k] > InitialSigma)
        Ev1_Sigma1[CurrentMember][j][k] = InitialSigma;
      Ev1- Weight 1 [CurrentMember][j][k] =
        Ev1- Weight 1 [CurrentMember][j][k] +
          Normal( Ev1_Sigma1[CurrentMember][j][k]);
    }
}
```

Layers 2 and 3 are mutated the same way as layer I shown above. The elite members (Mu) are copied to the next generation. Lambda new members are created through mutation and recombination; and
5. Go back to step 2.

The learning parameters for the evolutionary perceptron are:
1. Mu is the new of elite members of the population;
2. Lambda is the remaining members of the population generated using mutation and recombination;

3. Probability of Recombination determines how often two population members are combined to produce a new population member as shown below as population members i and j are combined;

```
w = RandomRea10;
for(n=O; n<25; n++)
{
  for(m=O; m<25; m++)
  {
    Ev1- Weight 1 [j][n][m] = w * Ev1- Weight 1 [i][n][m] +
        (l−w) * Evt Weight 1 [k][n][m];
  }
}
```

4. Initial Sigma is the initial sigma value used when the initial population is initialized as shown below for layer 1. Layers 2 and 3 are similar.

```
forG=O; j<25; j++)
{
  for(k=O; k<25; k++)
  {
    Ev1- Weight! [i][j][k] = 2*(RandomRealO−0.5);
      Ev1_Sigma1[i][j][k] = InitialSigma;
  }
}
```

5. SigmaLeamingRate in “Exp(SigmaLeamingRate*Normal(1))” controls the step size of the search; and
6. Number of Hidden Layer Neurons must be large enough to provide sufficient number of weights for the number cases and input dimensions.

Learning Rule-Based Classifier System.

The Classifier system capability, described in this patent, is currently imbedded in a discrete event simulation library CASSim in order to provide a proof of concept for the overall invention. It is expected that the Classifier system capability will be made available for hardware in the loop design and, subsequently, embeddable in various physical systems. The current Classifier system capability has been under development since 1985 as seen in references.

John H. Holland of the University of Michigan and the Santa Fe Institute (SFI) has promoted the idea of a classifier system for many years. Holland's classifier system receives input messages from the environment. Each of these messages is the output of a binary detector (011) that indicates if an environmental state or system condition exists or not. The classifier system next applies condition-action rules of the form “IF (1 ####) THEN (1000)” where (1 ####) represents the state of all conditions and (1000) represents the state of all action messages. The “#” is a “don't care” which means, given condition set (1 ####), if condition one was detected (has a value one) then the rule applies regardless any of the other conditions. However, a rule of the form “IF (10101) THEN (1000)” means that this rule applies only if all conditions have proper values. The first rule is much more general than the second rule because fewer conditions are required for it to apply. Associated with each rule is a BID value that can be a randomized function of all condition message confidences, overall rule confidence, and whether the rule is general or specific. When several rules apply in a particular condition context, the highest BID value is used to decide which rule actually fires (posts action messages).

Rules are adapted two ways: (1) when a payoff is received from the environment the chain of rules that fired leading to the payoff are appropriately rewarded or punished and (2) strong rules are recombined and mutated using genetic algorithms to produce new rules. Rules are rewarded by increasing their rule confidence values and punished by decreasing them. Thus, strong rules that are rewarded often have high rule confidence values and weak rules that are punished often have low rule confidence values. Finally, through rule strength modification and generation of new rules, strong rules persist and weak rules are eliminated from the classifier system.

Westerdale discusses the problem of rule strength modification. He compares the “Bucket Brigade Algorithm” used by Holland and others with another related approach called the “Profit Sharing Plan.” It is shown in the full paper of which (22) is a summary that the bucket brigade algorithm can diverge under some conditions; however, the profit sharing plan always converges if the learning rate is set small enough.

The Classifier capability described here is similar in concept but differs significantly in implementation. The Classifier capability is a rule-based, forward chaining, expert system controller that has rule learning ability. Experiments using the Classifier capability to learn a sequence of rules that “unlocks” a Finite State Machine and receives a payoff when the final state is reached demonstrated that the profit sharing plan converges when the learning rate is small enough. Further, in order to do reinforcement learning, the profit shared must be either decreased exponentially as the decisions in the learning span are rewarded or the learning span is reset when the goal is reached. Either can be done so that unrelated decisions are not rewarded. The classifier system block in CASSim uses reset

The Classifier capability operates conceptually similar to Holland's classifier system, but there are some major differences in implementation. First, the Classifier system capability receives input messages that are of the form “AttributeName=RealValue,” which represent each feature dimension value, that may be used as rule conditions. Holland uses binary (011) values for condition messages. Second, the Classifier Event Action block uses rules of the form:
Rule2:IF
   WI=very_low AND
   W2=large,
THEN
   RI=two AND
   R2=Three, CF=75%.

If an attribute name is not listed in a rule, it is the same as don't care “#” in one of Holland's rules. Therefore, rules that have few condition facts are general rules and rules that have many condition facts are specific rules, similar to Holland's rules. The method used to decide which rule fires is similar to Holland's classifier system; however, rule strength modification is done using the profit sharing plan method described by Westerdale.

From above rule, one can see that when a rule fires, the action messages must be transformed back to the form “AttributeName=RealValue.” This is required in any real world system where analog values or signals are used to decide an action, send a message, control a process, or change agent state.

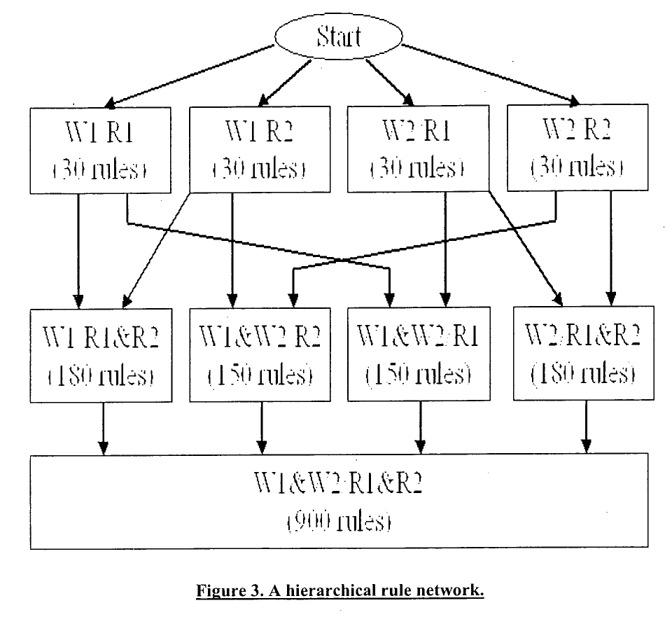

The induction operators that can be applied are change a fact value in the selected rule, add a new fact to the rule, and delete an old fact from the rule. These operators are applied to either the condition or action of a rule based on a probability. Another probability is used to decide whether to change a rule fact or add/delete a fact. Given add/delete is selected, a probability function is used to select either add or delete. Initially, this probability function is zero and then increases exponentially, as rules are modified, until a maximum value of 0.9 is reached. The result is that rule induction initially focuses on the most general rules at the top of the rule network, shown in FIG. 3, but eventually generates more specific rules further down the rule network.

In summary, the search for the best rules is guided by percent positive reward and proceeds from the top to the bottom of the rule network. A set of good rules to build on is discovered and then these building blocks are mutated and recombined to produce new more effective rules. The result is that a minimal set of the most general rules that can make all decisions correctly is found. Because of the inductive bias implicit in this evolutionary rule induction algorithm, only a small fraction of the total number of possible rules are examined.

Classifier System Decision Making Algorithm. The classifier system capability contains a forward chaining, inference engine that uses condition-action rules to transform condition attributes into action attributes. The basic inference algorithm used is described in Ignizio; however, the method used in Iquiz1019 for deciding which eligible rule will fire is different and it has no rule learning capability.

The condition attributes are obtained as input as discussed above. After inferencing is complete, action attributes are provided as output as discussed above. If several different actions are implied by the condition attributes (Le., several rules are eligible to fire in a context), the best action(s) is selected based on either the maximum BID value or a probability. The BID is a function of rule strength (confidence factor CF) and condition support. Simple GA classifiers often select an eligible rule to fire based on a normalized rule strength probability distribution. Again very strong rules lock out weak rules from being selected. The Classifier system capability employs a different approach where rules are selected for modification using rank selection based on rule strength. A linear probability distribution function is formed from the ranked rule strengths such that the strongest rule is ten times as likely to be selected as the weakest rule. This allows strong rules to be selected most of the time but occasionally weak rules fire. Rank selection creates a balance between exploitation of learned knowledge and exploration for new knowledge. Probability of rule selection is required for rule learning, but the maximum BID should be used once all rules have been determined in order best decide in ambiguous situations.

Process attributes of the form “AttributeName=RealValue” must be transformed into a symbolic form “AttributeName=ValueName” suitable for the inference engine. To do this, a range of numerical attribute values is associated with each symbolic value name. A command having the following format must be placed at the beginning of the rule file to accomplish the required transformation:
LegalConditionVals(AttributeName)=ValueName1(Low1:High1), . . . , ValueNameN(LowN:HighN)
LegalConditionVals(Feature I)=A(O:1.25),B(1.25:2.5),C(2.5:3.75), D(3.75:5),E(5:6.25),F(6.25:7.5),0(7.5:8.75),H(8.75:I0)
LegalConditionVals(Feature2)=A(0:1.25),B(I.25:2.5),C(2.5:3.75), D(3.75:5),E(5:6.25),F(6.25:7.5),0(7.5:8.75),H(8.75:10)
LegalConditionVals(Feature3)=A(0:1.25),B(1.25:2.5),C(2.5:3.75), D(3.75:5),E(5:6.25),F(6.25:7.5),0(7.5:8.75),H(8.75:10)
LegalActionVals(Decision)=No Warhead(O:O),One Warhead(1:I), TwoWarheads+(2:2)
Rule I:IF
   Feature1=A,
THEN
   Decision=NoWarhead, CF=50.0%
Rule 2:IF
   Feature1=B,
THEN
   Decision=NoWarhead, CF=50.0%
Rule 3:IF
   Feature1=C,
THEN
   Decision=NoWarhead, CF=50.0%
Rule 4:IF
   Feature1=D,
THEN
   Decision=NoWarhead, CF=50.0%

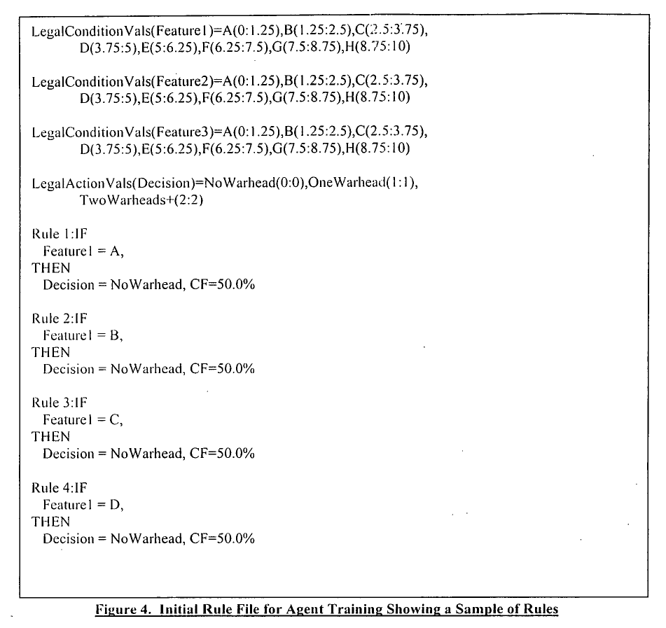

### FIG. 4. Initial Rule File for Agent Training Showing a Sample of Rules

For example, in FIG. 4, three feature dimensions are defined that divide the range 0-10 into eight crisp sets or feature facts A(0:1.25) through H(8.75:10). The Low and High values (L:H) define the range of numerical values allowed for each symbolic value name. The result of each transformation is a set of one or more facts of the form “AttributeName=ValueName” that can be used during the inferencing process. Further, a LegalActionVals command having the following format must be placed at the beginning of the rule file to accomplish the required reverse transformation when a rule fires:

LegalActionVals(AttributeName)=ValueName1(Low1:High1), . . . , ValueNameN(LowN:HighN)

The Low and High values define the range of numerical values allowed for each symbolic value name. For crisp rules a single value is specified; however, for fuzzy rules a range of values must be specified. The result of each transformation is one or more decision attributes of the form “AttributeName=RealValue” as discussed above. An example rule is as follows:
RuleName:IF
   ConditionName1=ValueName1 OR
   ConditionName1=ValueName2 AND
   ConditionName2=ValueName3,
THEN
   ActionName1=ValueName4 AND
   ActionName2=ValueName5, CF=100.0%

The condition of each rule must be in product of sums format “((A or B) and (C or D)).” For crisp logic rules, there is no problem having disjunctions “(A or B)” in the condition; however, for fuzzy rules disjunctions may not work correctly. The problem is that in a forward chaining inference process, the first true condition fact may cause a disjunctive rule to fire. The condition support for the rule may be greater if we wait for all condition facts to be considered, but there is no way to know when to wait.

If a rule name includes “constraint,” the rule always wins the competition. Further, the CF is always 100 and is never changed by learning. There are several uses for “constraint” rules.

First, constraint-rules impose constraints on actions that must not be changed by learning in order to place limits on system behavior. Second, in learning situations where some contexts are far more frequent than others, constraint-rules allow rules to be learned in stages. Rules generated for contexts already covered by constraint rules are quickly eliminated so that rule search can find rules for rare contexts.

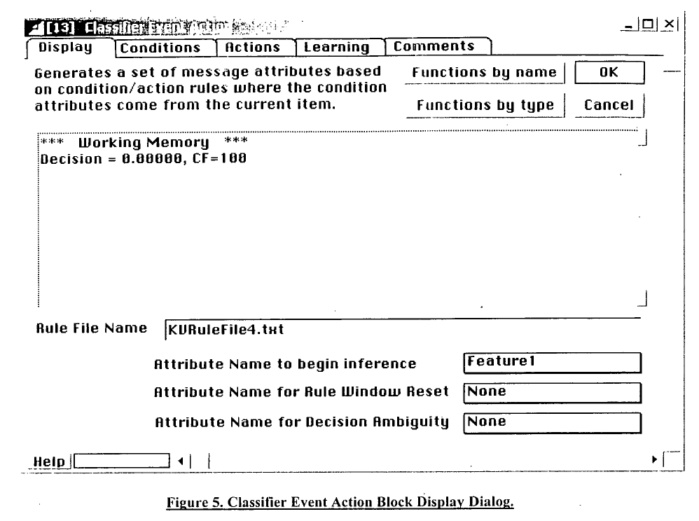

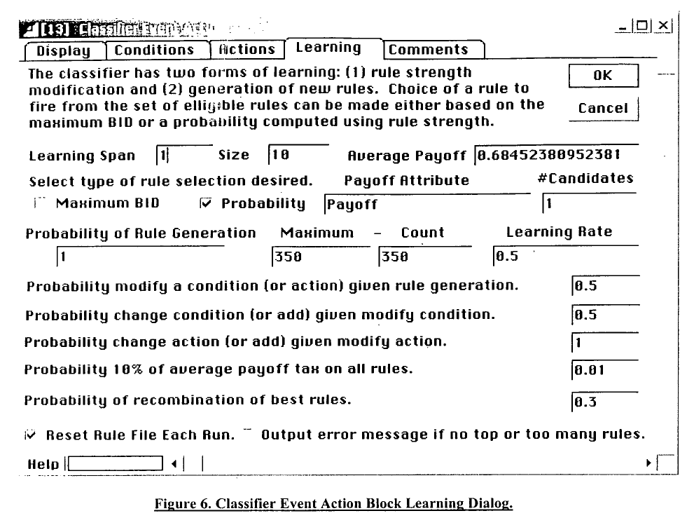

Classifier Cavabilitv Dialog Choices. FIGS. 5 and 6 show dialog boxes for the Classifier Event Action block. These dialogs identify the inputs and learning parameters required. Action block Display Dialog, shown in FIG. 5, displays one to many decision facts in the decision window. The rule file name, attribute name to begin inference, attribute name for rule window reset (used in reinforcement learning), and attribute name for decision ambiguity are also specified here. Ambiguity measures the degree to which alternative conflicting discrimination decisions exist for a given decision.

RuleFileName. Defines the rule file name that contains rule condition and action feature fact and rule definitions.

InitialFact. The forward chaining inference engine requires an attribute name to begin the reasoning process. Select an attribute name and value that is always available and in the condition of at least one rule.

Reset. Attribute name for rule window reset. The rule window has specified length Memory Size and contains the fired rule, simulated process identifier, and a list of all eligible rules for a sequence of decisions. The window is shifted for each decision to be placed at the top of the list after inferencing is complete. When the reset attribute is one, the rule window is cleared so that unrelated decisions will not be rewarded.

Ambiguity. The ambiguity attribute is part of the output of the Classifier capability and contains degree of ambiguity in the current decision. Ambiguity results when there are several alternative decisions eligible to fire and describes the relative rule strengths of the eligible rules.

Condition Names. Up to 16 condition attribute names to be used in rules can be specified in the condition dialog.

Action Names. Up to 16 action attribute names to be used in rules can be specified in the action dialog.

Classifier Event Action block Learning Dialog, shown in FIG. 4, allows the parameters to be specified that control rule learning. When the learning span is set to zero, learning is shut off. During rule learning, probability is used to maintain a balance between exploration and exploitation; however, during agent operation it is better to use maximum bid since this helps to better deal with ambiguity.

LearningSpan. If LearningSpan is greater than zero, the Classifier Capability can learn through rule strength modification and generation of new rules. The Classifier Capability receives a reward payoff message from a Reward Event Action block. Such a message contains the payoff attribute name, a process identifier, and the payoff value. If the payoff name and process identifier in a message are proper for a classifier block, a rule sequence is rewarded using profit sharing with penalty. Rules that initially received positive reward are rewarded equally in the profit sharing plan. The best way to reduce learning noise is to reset the window when goal is achieved.

MemorySize. The MemorySize should be set to the learning span times the maximum number of concurrent process instances expected. Because a process identifier is part of the reward message, many concurrent process instances can be rewarded simultaneously. Each process instance has an independent rule sequence in the memory of length LearningSpan. Indeed, this feature reduces all of the learning noise that would occur if all process instances were combined into one rule sequence.

MaximumBID. If the MaximumBID check box is checked, rules are selected on the basis of maximum BID strength. IfMaximumBID is checked, Probability can not be checked.

Probability. If the Probability check box is checked, rules are rank selected based on a probability computed using rule strength as discussed above. If Probability is checked, MaximumBID can not be checked.

PayoffAttributeName. The Reward Event Action block broadcasts a reward payoff message to all classifier blocks in a model. The message contains a payoff attribute name, which is compared against the PayoffAttributeName specified in the learning dialog. If the names compare, then the classifier block can accept the message.

#Candidates. When a rule is rewarded, the number of positive rewards and total number of rewards is counted and percent positive reward is computed. If the set of eligible rules have more than the specified number of rules having 100 percent positive reward, rule generation stops. This allows rule learning to focus on other contexts.

Ambiguity Threshold: Defines number of rules generated in a context before ambiguity is used to couted rule search.

PrbRuleGen. This probability parameter is used to decide if rule generation will occur when a payoff message is received, accepted, and the fired rule for the decision context is rewarded. Rules are rank selected for modification as discussed above. Rule generation proceeds from general to more specific rules.

MaxRuleCount. The MaxRuleCount parameter controls the maximum number of rules generated in a run. Once all rules have been generated, rule strength modification eliminates weak rules, retaining a minimal set of the most general rules that can make all decisions correctly.

LearningRate. LearningRate, sigma, controls the amount each rule is rewarded or penalized. If the LearningRate is too high, good rules can be lost due to bad luck. If the LearningRate is too low, learning is slow. Finding the correct LearningRate (and LearningSpan) is a trial and error process, but it is critical that the correct LearningRate and Learning Span be determined. A similar problem occurs in neural network learning in that the learning rate and number of hidden layer nodes must be just right.

PrbModCondition. Given that rule generation has been selected, this probability parameter is used to decide if a condition or an action will be modified.

PrbChgCondition. Given that “modify a condition” has been selected, this probability parameter is used to decide if a condition fact value name will be changed or if a condition fact will be added or deleted. Given that add/delete has been selected, a probability function is used such that initially the probability of adding is zero, but it increases exponentially to a value of 0.9 as rules are generated. This feature allows the rules at the top of the rule network, shown in FIG. 1, to be more fully explored and evaluated. The selection of which condition fact to change is uniformly distributed.

PrbChgAction. Given that “modify an action” has been selected, this probability parameter is used to decide if an action fact value name will be changed or if an action fact will be added or deleted. Given that add/delete has been selected, a probability function is used such that initially the probability of adding is zero, but it increases exponentially to a value of 0.9 as rules are generated. The selection of which action fact to change is uniformly distributed.

PrbRuleBaseTax. If a rule is generated that matches no contexts, the rule is never eligible and thus never fires. There is no way to eliminate such a rule through rule strength modification discussed above. Therefore, a tax on each such rule of ten percent of average payoff is levied randomly based on the PrbRuleBaseTax. As the eligibility of a rule increases, the probability of applying a tax to the rule decreases linearly. The value of this probability must selected so that good rules, that are delayed in being eligible, are not eliminated along with the useless ones.

PrbRecombination. Probability of recombination is used to decide if two rank selected rules will be recombined.

Reset Rule File. If this box is checked, the rule file is reloaded at the beginning of each run. This is required to allow each feature map population member a chance to generate a set of rules of its own.

Output Error Message. If this box is checked, no error message is displayed when the rules fail to be able to decide. This happens under two conditions: (1) no rule is eligible in a context or (2) two many rules are eligible in a context. This avoids program pause to respond to a message during feature map learning. If such a failure occurs the program aborts the run and goes to the next population member. It is not uncommon to have the rules fail during feature map learning.

Summary of Classifier Capability. The Classifier Event Action block contains a forward chaining inference engine that uses condition-action rules to transform condition attributes into action attributes. The condition attributes (such as Feature1, Feature2, and Feature3 in FIG. 4) are obtained from a process instance item passing through the block. After the inference algorithm has completed selecting a rule to “fire” or execute, the action attributes of the selected rule are added to the process instance item passing through the block before the item is sent to the output connector. In FIG. 4, the discrimination decisions are no warhead (value 0), one warhead (value 1), and two warheads+ (Value 2).

There are two alternative mechanisms to train and arbitrate between competing rule sets. Specifically, if several different rules are implied by the condition attributes (i.e., several rules are eligible to fire in a particular context), the rule selected for application in the specific instance can be generated and selected by one of two processes: based on either a maximum BID value or a rule selection probability. Here, BID value is a score that the learning process maintains for a particular rule set. Maximum BID value is a function of rule strength, specificity and condition support. Rule selection probability is a linear function of rule rank which is based on rule strength. If the learning span is greater than zero, either maximum BID value or rule selection probability can be used during the generation of new rules. Rule rank selection probability allows all eligible rules a chance to specify the action attributes, but the highest ranked rule is ten times as likely as the least ranked rule to do so. This allows both exploitation of the current best rules and exploration for better future rules to occur concurrently. Maximum BID allows evaluation of alternative rules in order to fine tune decision-making performance in the event that the decision remains ambiguous. This can occur if the condition attributes are insufficient to unambiguously classify all decision situations. The result of either process is that the most general rule correctly covering all situations emerges as the best rule. Either maximum BID value or rule selection probability can be used after rule learning is complete, but maximum BID is better when there are ambiguous situations present. This conclusion is based on experiments done with the AASFOVM simulation.

Rule induction begins with a small set of very general rules as shown in FIG. 3 such that each possible value for one condition fact is covered. The classifier block uses these rules to make decisions and the reward block evaluates the quality of each decision. This is done by comparing the decision of the classifier block with the correct classification included in the case file, sending a payoff to the classifier block. The classifier uses the payoff to reward or punish the rules. The result is that rule strength increases for good rules and decreases for bad rules. If the correct classification is not known and decision grade can be computed based on system MOEs.

Rules are rank selected for modification based on rule strength. Rule generation proceeds from general to more specific rules. Using the #candidates cutoff in the Classifier block learning dialog, the search for rules is focused on contexts where better rules are needed. Further, ambiguity threshold is also used to control rule search. This strategy for selecting rules allows a sequence of planning rules to be discovered rather than just stimulus-response rules.

### REFERENCES TO DETAILED DESCRIPTION SECTION

[1]. Clymer, l. R., Systems Analysis Using Simulation and Markov Models, Englewood Cliffs, NJ: Prentice-Hall Inc, 1990.

[2]. Clymer, J. R., “System Design Using OpEM Inductive/Adaptive Expert System Controller”, IN lASTED International Journal of Modeling & Simulation, Volume 10, Number 4, 1990, pages 129-136.

[3]. Clymer, J. R., Corey, P. D., and J. Gardner, “Discrete Event Fuzzy Airport Control”, IN IEEE Transactions on Systems, Man, and Cybernetics, Volume 22, Number 2, MarchApril 1992, pages 343-351.

[4]. Clymer, J. R., D. J. Cheng, and D. Hernandez, “Induction of Decision Making Rules for Context Sensitive Systems”, IN Simulation, San Diego, Calif.: The Society of Computer Simulation International, September 1992 issue, Volume 59, Number 3, pages 198-206.

[5]. Clymer, J. R., P. D. Corey, and H. Bandukwala, “Induction of Classification Rules From Noisy Sonar Features”, IN Simulation, San Diego, Calif.: The Society of Computer Simulation International, April 1994 issue, Volume 62, Number 4, pages 256-267.

[6]. Clymer, J. R., “Induction of Fuzzy Rules for Air Traffic Control”, IN Proceedings1995 IEEE International Conference on Systems, Man, and Cybernetics, Vancouver, British Columbia, Canada, Oct. 22-25, 1995, pages 1495-1502.

[7]. Clymer, J. R., “Expansionist/Context-Sensitive Methodology: Engineering of Complex Adaptive Systems”, IN IEEE Transactions on Aerospace and Electronic Systems, April 1997 issue, Volume 33, Number 2, pages 686-695.

[8]. Clymer, J. R., “Simulation-Based Engineering of Complex Adaptive Systems,” In Simulation, Journal of the Society of Computer Simulation, San Diego, Calif., Volume 72, Number 4, April 1999 issue, pages 250-260.

[9]. Clymer, J. R., “Optimization of Simulated Systems Effectiveness using Evolutionary Algorithms,” IN Simulation, Journal of the Society of Computer Simulation, San Diego, Calif., Volume 73, Number 6, December 1999, pages 334-340.

[10]. Clymer, J. R., Optimizing Production Work Flow using OpEMCSS,” Proceedings of the 2000 Winter Simulation Conference, WSC 2000, 10-13 December 2000, Orlando, Fla., 2000, pages 1305-1314.

[11]. Clymer, J. R. and D. E. Cheng, “Simulation-Based Engineering of Complex Adaptive Systems Using a Classifier Block,” Proceedings of the Advanced Simulation Technologies Conference (ASTC), Seattle, Wash. Apr. 22-26, 2001.

[12]. Clymer, J. R. Simulation-Based Engineering of Complex Systems, Placentia, Calif.: John R. Clymer and Associates, 2001.

[13]. Clymer, l R., “Simulation of a Vehicle Traffic Control Network Using a Fuzzy Classifier System,” Proceedings of the Advanced Simulation Technologies Conference (ASTe), San Diego, Calif., Apr. 14-18, 2002.

[14]. Clymer, l R. and V. Harrison, “Simulation of Air Traffic Control at a VFR airport Using EXTEND+MFG+OpEMCSS5,” proceedings of the 21 st Digital Avionics Systems Conference, Oct. 27-31, 2002.

[15]. Clymer, l R., “Simulation-Based Engineering of Complex Systems Using EXTEND+MFG+OpEMCSS,” Proceedings of the 2002 Winter Simulation Conference, WSC Dec. 8-11, 2002, San Diego Calif., pages 147-156.

[16]. Fogel, D. B., Evolutionary Computation: Toward a New Philosophy of Machine Intelligence, The IEEE Press, Piscataway, N.J., 1995.

[17]. Haussler, D., “Quantifying Inductive Bias: AI Learning Algorithms and Valiant's Learning Framework,” IN Artificial Intelligence, 36, 1988, pages 177-222. 13.

[18]. Holland, J. H., Hidden Order, Addison-Wesley, 1995.

[19]. Ignizio, J. P., Introduction to Expert Systems: The Development and Implementation of Rule-Based Exert Systems, McGraw-Hill, 1991.

[20]. Pal, N. R. and V. K. Eluri, “Two Efficient Connectionist Schemes for Structure Preserving Dimensionality Reduction,” IEEE Transactions on Neural Networks,” Volume 9, Number 6, November 1998, pages 1142-1154.

[21]. Sammon, J. W., A Nonlinear Mapping for Data Structure Analysis,” Transactions on Cpmputers, Volume C18, Number 5, May 1969, pages 401-409.

[22]. Westerdale, T. R., “An Approach to Credit Assignment in Classifier Systems,” IN Complexity, Journal ofthe Santa Fe Institute, Volume 4, Issue 2, 1998, pages 49-52.

What is claimed:

1. A rules-based system for effecting computer implemented decision support, the system comprising:
1) a Feature Map comprising information relevant to a specified problem;
2) a learning Classifier capable of selecting and ordering rules for generating solutions to the specified problem;
3) means for dynamically interacting with the at least one of selectable candidate solutions for generating a refined set of candidate solutions; and,
4) means for outputting or communicating the at least one selectable candidate solution to an appropriate displaying device or agent requiring solutions input.

2. A system according to claim 1, wherein said Feature Map comprises a self-organizing feature map.

3. A system according to claim 1, wherein said Feature Map further comprises an evolutionary perceptron.

4. A system according to claim 3, wherein said evolutionary perceptron comprises evolutionary algorithms that evolve populations of output features sets that are inputs to the learning classifies

5. A system according to claim 4, wherein said Feature Map further comprises a set of exemplars, which said exemplars are provided as initial or starting values.

6. A system according to claim 5, wherein said Feature Map further comprises the ability to receive input data and map it into the closest said exemplar.

7. A system according to claim 1, wherein said Classifier further comprises evolutionary optimization techniques.

8. A system according to claim 1, wherein said Classifier further comprises evolutionary programming that allows said Classifier to search through the set of all possible rules rule space from most general to most specific.

9. A system according to claim 1, wherein said Classifier further comprises the ability to evaluate the best-fitting rules and produce a decision.

10. A system according to claim 1, wherein said system is capable of classifying input cases into a predetermined number of sets.

11. A system according to claim 1, wherein said system is capable of deriving solutions that achieve predetermined system goals.

12. A system according to claim 1, wherein said system is capable of transmitting solutions to output devices and to thereby control the operation of said output devices.

13. A system according to claim 1, wherein said system is capable of controlling the operation of a traffic signal light.

14. A system according to claim 1, wherein said system is capable of reducing the number of state vector dimensions to a level acceptable for rule learning.

15. A system according to claim 1, wherein said system is capable of providing targeting solutions to an output targeting apparatus.

16. A system according to claim 1, further comprising a computer program to operate said system on a computer.

17. A system according to claim 1, wherein said system can be trained ahead of use using a training set of cases.

18. A system according to claim 1, wherein said system can be trained from a set of training cases developed by a simulation model.

19. A computer program readable by a machine, tangibly embodying a program of instructions executable by a machine to perform system steps for effecting computer implemented decision support, the system comprising the steps of:
1) collecting within a Feature Map information relevant to a specified problem;
2) selecting and ordering rules for generating solutions to the specified problem, via a learning Classifier;
3) dynamically interacting with the at least one of selectable candidate solutions for generating a refined set of candidate solutions; and,
4) outputting or communicating the at least one selectable candidate solution to an appropriate displaying device or agent requiring solutions input.

20. A computer program readable by a machine, tangibly embodying a program of instructions executable by a machine to perform system steps for effecting computer implemented decision support, the system comprising the steps of:
1) collecting within a Feature Map information relevant to a specified problem;
2) selecting and ordering rules for generating solutions to the specified problem, via a learning Classifier;
3) dynamically interacting with the at least one of selectable candidate solutions for generating a refined set of candidate solutions;
4) evolutionarily iterating said solutions until a final decisive solution is reached; and,
5) outputting or communicating the at least one selectable candidate solution to an appropriate displaying device or agent requiring solutions input.

21. A computer implemented rules-based method for effecting decision support, the method comprising:
1) constructing a Feature Map comprising information relevant to a specified problem;
2) utilizing a learning Classifier to select and order rules for generating solutions to the specified problem, based on input from said Feature Map;
3) dynamically interacting with the at least one of selectable candidate solutions for generating a refined set of candidate solutions; and,
4) outputting or communicating the at least one selectable candidate solution to an appropriate displaying device or agent requiring solutions input.

22. A method according to claim 21, wherein said Feature Map comprises a self-organizing feature map.

23. A method according to claim 21, wherein said Feature Map further comprises an evolutionary perceptron.

24. A method according to claim 3, wherein said evolutionary perceptron comprises evolutionary algorithms that evolve populations of new feature sets.

25. A method according to claim 4, wherein said Feature Map further comprises a set of exemplars, which said exemplars are provided as initial or starting values.

26. A method according to claim 5, wherein said Feature Map further comprises the ability to receive input data and map it into the closest said exemplar.

27. A method according to claim 21, wherein said Classifier further comprises evolutionary optimization techniques.

28. A method according to claim 21, wherein said Classifier further comprises evolutionary programming that allows said Classifier to search through the set of all possible rules (rule space) from most general to most specific.

29. A method according to claim 21, wherein said Classifier further comprises the ability to evaluate the best-fitting rules and produce a decision.

30. A method according to claim 21, wherein said method is capable of classifying input cases into a predetermined number of sets.

31. A method according to claim 21, wherein said method is capable of deriving solutions that achieve predetermined system goals.

32. A method according to claim 21, wherein said method is capable of transmitting solutions to output devices and to thereby control the operation of said output devices.

33. A method according to claim 21, wherein said method is capable of controlling the operation of a traffic signal light.

34. A method according to claim 21, wherein said method is capable of reducing the number of state vector dimensions to a level acceptable for rule learning.

35. A method according to claim 21, wherein said method is capable of providing targeting solutions to an output targeting apparatus.

36. A method according to claim 21, further comprising a computer program to operate said method on a computer.

37. A method according to claim 21, wherein said method can be trained ahead of use using a training set of cases.

38. A method according to claim 21, wherein said method can be trained from a set of training cases developed by a simulation model.

39. A method employing a computer program readable by a machine, tangibly embodying a program of instructions executable by a machine to perform system steps for effecting computer implemented decision support, the method comprising the steps of:
1) collecting within a Feature Map information relevant to a specified problem;
2) selecting and ordering rules for generating solutions to the specified problem, via a learning Classifier;
3) dynamically interacting with the at least one of selectable candidate solutions for generating a refined set of candidate solutions; and,
4) outputting or communicating the at least one selectable candidate solution to an appropriate displaying device or agent requiring solutions input.

40. A method employing a computer program readable by a machine, tangibly embodying a program of instructions executable by a machine to perform system steps for effecting computer implemented decision support, the method comprising the steps of:
1) collecting within a Feature Map information relevant to a specified problem;
2) selecting and ordering rules for generating solutions to the specified problem, via a learning Classifier;
3) dynamically interacting with the at least one of selectable candidate solutions for generating a refined set of candidate solutions;
4) evolutionarily iterating said solutions until a final decisive solution is reached; and,
5) outputting or communicating the at least one selectable candidate solution to an appropriate displaying device or agent requiring solutions input.
